(19) United States
(12) Patent Application Publication
(10) Pub. No.: US 2005/0100731 A1
(43) Pub. Date: May 12, 2005

(54) Mark transfer tape, mark transfer tape cartridge, and mark transfer tool

(75) Inventor: Kazuhito Sakamoto, Hirakata-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: UNION CHEMICAR CO., LTD., Hirakata-shi (JP)

(21) Appl. No.: 10/873,515

(22) Filed: Jun. 23, 2004

(30) Foreign Application Priority Data
Jun. 27, 2003 (JP) 2003-185728

(51) Int. Cl. B32B 7/12

(52) U.S. Cl. 428/354

(57) ABSTRACT

The present invention provides a mark transfer tape, a mark transfer tape cartridge, and a mark transfer tool which can clearly display the outline and color of a transferred mark and accurately display the form thereof. The mark transfer tape 1 comprises: a base tape 11, and at least a surface protective layer 12, a mark layer 14, and a pressure sensitive adhesive layer 13, the layers being laminated in this order on one surface of the base material 11. The surface protective layer 12 has a thickness of 1 to 20 μm, a total luminous transmittance of 50% or more, and an elongation percentage of 20 to 200% at ordinary temperatures. The mark transfer tape cartridge comprises: at least a supply unit, a take-up unit, and a transfer head unit for a mark transfer tape 1, wherein the mark transfer tape is fed from the supply unit, and is taken up on the take-up unit via the transfer head unit, and the mark transfer tape is composed of the above-described mark transfer tape 1. The mark transfer tool uses the above-described mark transfer tape 1.

### BACKGROUND OF THE INVENTION

(1) Field of the Invention

The present invention relates to a mark transfer tape, a mark transfer tape cartridge, and a mark transfer tool for transferring marks, such as characters, patterns, etc.

(2) Description of the Related Art

Marks, such as characters, patterns, etc., are currently attached to a sheet of paper or other flat surface, for example, marking documents or other materials, attaching images to postcards or other materials, or attaching identifying patterns to handheld items. The attachment of stamps, seals, etc., is a simple method, and is widely done by adults and children.

A mark transfer tool using a mark transfer tape is proposed as a method for use in addition to the above-described method (e.g., Japanese Unexamined Patent Publication No. 2002-337830). FIG. 5 is an elevation view illustrating the configuration inside the body of the mark transfer tool. A mark transfer tool 50 comprises a hand-held case 51 and a cartridge 52 detachably installed in the case 51. The cartridge 52 is provided with a transfer head 53. The cartridge 52 is provided with a cartridge case 54. In the cartridge case 54, a supply reel 56 for paying out the mark transfer tape 55 and a take-up reel 57 for taking up the tape (base tape) after a mark is transferred are rotatably installed, and, further, a transfer head 53 for pressing and transferring the mark transfer tape 55 to a sheet of paper or the like is installed therein rotatably about its axial center.

The cartridge 52 is configured such that the mark transfer tape 55 is wound onto the supply reel 56, the mark transfer tape 55 is fed from the supply reel 56, and the tape (base tape) is wound on the take-up reel 57 via the mark transfer head 53 after a mark is transferred.

FIG. 6 is a cross section view illustrating the structure of the mark transfer tape 55 for use in the above-described mark transfer tool 50. A surface protective layer 62, a mark layer 64, and a pressure sensitive adhesive layer 63 are laminated in this order on the surface of a base tape 61. The reference character M denotes a mark formed in the mark layer 64.

When the mark transfer tape 55 is pressed, for example, onto a sheet of paper with the transfer head 53, the pressure sensitive adhesive layer 63 adheres to the sheet of paper, and then the mark layer 64 and the surface protective layer 62, which are integrally formed thereon, are also left on the sheet together with the pressure sensitive adhesive layer 63, thus transferring the mark. The surface protective layer 62 is almost transparent, and is located on the mark layer 64 upon the sheet of paper, thereby protecting the mark that is transferred to the sheet from damage or deterioration.

The above-described surface protective layer is an indispensable layer for protecting the mark, which includes characters, patterns, etc. (hereinafter simply referred to as “mark”). However, such effects are not always exhibited simply because the surface protective layer is almost transparent. Depending on the properties of the surface protective layer, the transferred mark may be indistinct, or cracking may occur in the surface protective layer, which leads to inaccurate display or deformation of the mark.

### BRIEF SUMMARY OF THE INVENTION

The present invention has an object of providing a mark transfer tape, a mark transfer tape cartridge, and a mark transfer tool which can sharply display the outline and color of a mark and accurately display the form.

In order to solve the above-described problems, the mark transfer tape according to the present invention comprises: a base tape, and at least a surface protective layer, a mark layer, and a pressure sensitive adhesive layer, the layers being laminated in this order on one surface of the base tape, wherein the surface protective layer has a thickness of 1 to 20 μm, a total luminous transmittance of 50% or more, and an elongation percentage of 20 to 200% at ordinary temperatures.

According to the mark transfer tape, since the thickness, total luminous transmittance and elongation percentage of the surface protective layer are limited to the above ranges, a coating film composed of the surface protective layer, the mark layer and the pressure sensitive adhesive layer exhibits an excellent cutting performance when it is transferred to a transfer target, and cracking and elongation are not likely to occur in the surface protective layer after the transfer. Further, since the surface protective layer is excellent in transparency, the transferred mark exhibits a clear outline and color, and an accurate form.

The mark transfer tape cartridge according to the present invention comprises: a supply unit, a take-up unit, and a transfer head for a mark transfer tape, wherein the mark transfer tape is fed from the supply unit, and is taken up on the take-up unit via the transfer head unit, and the mark transfer tape is the above-described mark transfer tape of the present invention.

According to the above-described mark transfer tape cartridge, the mark transfer tape can be easily inserted in and removed from the mark transfer tool, and further, since the above-described mark transfer tape of the present invention is used, the coating film exhibits an excellent cutting performance at the time of the transfer, and the transferred mark exhibits a clear outline and color, and an accurate form.

The mark transfer tool (1) according to the present invention comprises: a case forming an outer frame, and the above-described mark transfer tape cartridge of the present invention removably installed in the case.

The mark transfer tool (2) according to the present invention comprises: a case forming an outer frame in which a supply unit, a take-up unit, and a transfer head unit for a mark transfer tape are installed; wherein the mark transfer tape is fed from the supply unit, and is taken up on the take-up unit via the transfer head unit, and the mark transfer tape is the above-described mark transfer tape of the present invention.

According to the above-described mark transfer tool (1) or (2), a transfer tool configured as described above can be manipulated by one hand, thereby facilitating the transfer of a mark to a sheet of paper or the like. Further, since the above-described mark transfer tape of the present invention is used for the mark transfer tape, the coating film exhibits an excellent cutting performance at the time of the transfer and the transferred mark exhibits a clear outline and color, and an accurate form.

### BRIEF DESCRIPTION OF SEVERAL VIEWS OF THE DRAWING

FIG. 1 is a cross section view schematically illustrating a cross-sectional structure of a mark transfer tape according to one embodiment of the present invention.

FIG. 2 is a view illustrating one example of a mark in a mark layer of the mark transfer tape according to one embodiment of the present invention.

FIG. 3 is a perspective view schematically illustrating a mark transfer tape cartridge according to one embodiment of the present invention.

FIG. 4 is a cross section view schematically illustrating the structure inside the mark transfer tool according to one embodiment of the present invention.

FIG. 5 is an elevation view illustrating the configuration inside a prior-art mark transfer tool.

FIG. 6 is a cross section view illustrating the structure of a mark transfer tape for use in a prior-art mark transfer tool.

### DETAILED DESCRIPTION OF THE INVENTION

A mark transfer tape, mark transfer tape cartridge, and mark transfer tool of the present invention are now described below in detail with reference to drawings. In the drawings, the same parts or equivalent parts are designated by the same reference numerals, and their descriptions may be omitted.

FIG. 1 is a cross section view schematically illustrating a cross-sectional structure of a mark transfer tape according to one embodiment of the present invention. The mark transfer tape 1 shown in FIG. 1 comprises a base tape 11, a surface protective layer 12, a pressure sensitive adhesive layer 13 and a mark layer 14 sandwiched between the surface protective layer 12 and the pressure sensitive adhesive layer 13. The surface protective layer 12 and the pressure sensitive adhesive layer 13 directly contact each other except in the mark parts M of the mark layer. For easy separation between the base tape 11 and the surface protective layer 12, a release layer (not shown) composed of a silicone resin, a fluorine resin, etc., may be formed between the base tape 11 and the surface protective layer 12. The surface protective layer 12, the mark layer 14, and the pressure sensitive adhesive layer 13, excluding the base tape 11, are collectively referred to as a “coating film”.

The base tape 11 is composed of a synthetic resin film, such as polyethylene terephthalate, polypropylene, glassine, etc. The thickness of the base tape 11 is preferably in the range of 5 to 100 μm. When the thickness of the base tape 11 is above this range, the transfer pressure at the time of transfer lowers, which frequently results in insufficient transfer. When the thickness of the base tape 11 is below this range, the tape strength weakens, which sometimes results in tearing of the tape.

The pressure sensitive adhesive layer 13 is preferably composed of adhesive materials, such as synthetic resins, including acrylic type resins, vinyl ether type resins, etc., or rubber type materials. The pressure sensitive adhesive layer 13 may contain additives as needed: tackifiers such as a rosin and a rosin derivative, a terpene polymer, a petroleum resin, etc.; antioxidants such as a phenol type antioxidant, a phosphorus type antioxidant, etc.; ultraviolet absorbers, such as a p-aminobenzoic type absorber, a benzophenone type methoxy cinnamic-acid derivative absorber, a salicylic acid derivative absorber, etc. The thickness of the pressure sensitive adhesive layer 13 is preferably in the range of 0.3 to 5 μm, more preferably 0.5 to 3 μm. When the thickness is above this range, the coating film may not be easily cut at the time of transfer, while when the thickness is below this range, the coating layer may not sufficiently adhere to the transfer target, such as a sheet of paper or the like.

The surface protective layer 12 contains as a principal component at least one of a urethane resin, a polyethylene resin, a polystyrene resin, an acrylic resin, a styrene-butadiene block copolymer, a melamine resin, an epoxy resin, etc., and may, as needed, contain surfactants, such as anionic, cationic, amphoteric, nonionic surfactants, etc., antioxidants, such as a phenol type antioxidant, a phosphorus type antioxidant, etc., ultraviolet absorbers, such as a p-aminobenzoic-acid type derivative, a benzophenone type methoxy cinnamic-acid derivative, a salicylate derivative, etc. The surface protective layer 12 may be colored using a pigment and a dye or made colorful by using a pearl pigment, lame, etc. However, it is preferable to adjust the color tone and the depth of the color so that the color and form of the mark transferred from the mark transfer tape 1 are clearly visible.

The thickness of the surface protective layer 12 is preferably within the range of 1 to 20 μm, more preferably 3 to 15 μm. When the thickness of the surface protective layer 12 is less than 1 μm, the color and form of the mark transferred may not be clearly displayed. This is because a resin constituting the surface protective layer 12 cannot withstand the external force caused by distortion, etc., and thus cracking may occur in the transferred coating film.

On the other hand, when the thickness of the surface protective layer 12 exceeds 20 μm, the following problems may arise. Since the cutting performance lowers when the coating film is cut by the transfer head part, the coating film may not be cut at the predetermined position after the mark is pressed and transferred. Further, since the transparency (total luminous transmittance) of the coating film lowers, the sharpness of the outline and color of the mark tend to be lost at the time of transfer. Still further, since the total thickness of the base tape 11 and the coating film increases excessively, the length of the mark transfer tape to be contained in the mark transfer tool is short, and thus the amount of tape contained decreases.

The surface protective layer 12 is transparent enough to satisfy a predetermined standard, and the total luminous transmittance obtained by the procedure prescribed in ASTM D-1003 is 50% or more. When the total luminous transmittance is less than 50%, the outline and color of the mark in the coating film transferred tend to be indistinct due to poor transparency of the surface protective layer 12.

The transparency of the surface protective layer 12 can be adjusted by controlling the amount of polystyrene resin, acryl resin, etc., which easily attain high transparency. On the other hand, extender pigments, such as pigments, fillers, etc., are apt to disadvantageously reduce the transparency even though extender pigments favorably increase the cutting performance when transferring, and therefore the amount thereof is determined by considering the desired transparency.

The elongation percentage of the surface protective layer 12 also needs to be in an appropriate range. More specifically, the elongation percentage obtained according to the procedure prescribed in ASTM D-412 is preferably within the range of 20 to 200%, and more preferably 50 to 100%. When the elongation percentage is less than 20%, cracking is likely to occur in the transferred surface protective layer 12, thus tending to make the outline and color of the mark unclear. On the other hand, when the elongation percentage exceeds 200%, the mark may be transferred with the surface protective layer 12 in an elongated condition. In this case, the transferred mark is also elongated and thus the form may not be transferred accurately. Further, due to the poor cutting performance of the coating film when it is cut after the mark is pressed and transferred, the coating film may not be cut at the predetermined position.

The elongation percentage of the surface protective layer 12 can be adjusted by controlling the amount of urethane resin, styrene-butadiene copolymer, etc., which raise the elongation percentage, and polystyrene resin, acryl resin, etc., which reduce the elongation percentage.

Samples for measuring the total luminous transmittance and elongation percentage of the surface protective layer 12 can be produced by coating the material for the surface protective layer onto a predetermined base tape, drying the coated material at about 80° C., and then peeling the surface protective layer from the base tape. The thickness of the sample for measuring the total luminous transmittance is about 10 to about 20 μm, and that of the sample for measuring the elongation percentage is about 20 to about 50 μm with a width of about 30 to about 50 mm.

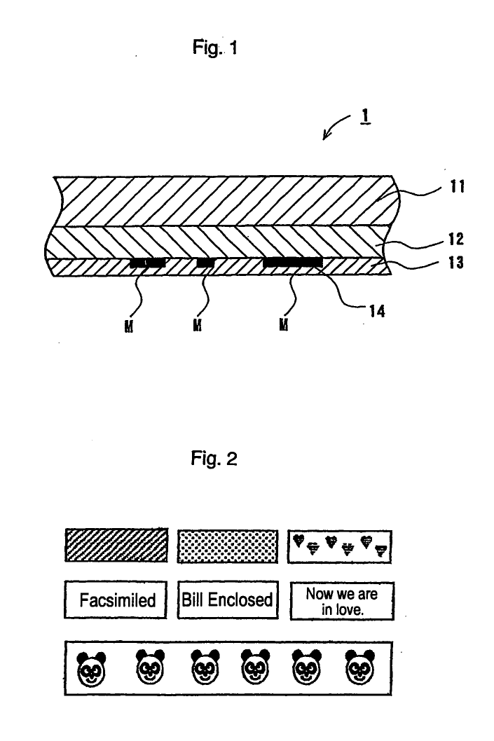

FIG. 2 is a view illustrating an example of marks (characters and patterns) drawn on the mark part M of the mark layer 14. These characters and patterns can be freely selected. The mark part M of the mark layer 14 composed of such characters and patterns can be formed on the surface protective layer 12 shown in FIG. 1 by using printing methods, such as gravure printing, offset printing, screen printing, pad printing, ink-jet printing, etc.

The mark transfer tape 1 configured as described above can be manufactured by the following procedure. In the following description of the manufacturing method, the material, thickness, etc., of each layer are as described above, and thus the descriptions are omitted.

First, a base tape 11 is wound onto a roll. A release layer is formed thereon as needed by using a printing method, such as gravure printing, dye printing, reverse printing, etc. Subsequently, a surface protective layer 12 is formed on the base tape 11 or the release layer in the same manner as that used for the release layer. The mark M is printed on the surface protective layer 12 after the surface protective layer 12 is dried at about 80° C. by gravure printing, offset printing, screen printing, pad printing, ink-jet printing, etc. A pressure sensitive adhesive layer 13 is further formed thereon by gravure printing, dye printing, reverse printing, etc. As described above, since a ribbon-shaped material wound around a roll is used for the base tape 11, the base tape 11 is cut into a predetermined width and length after the coating film is formed.

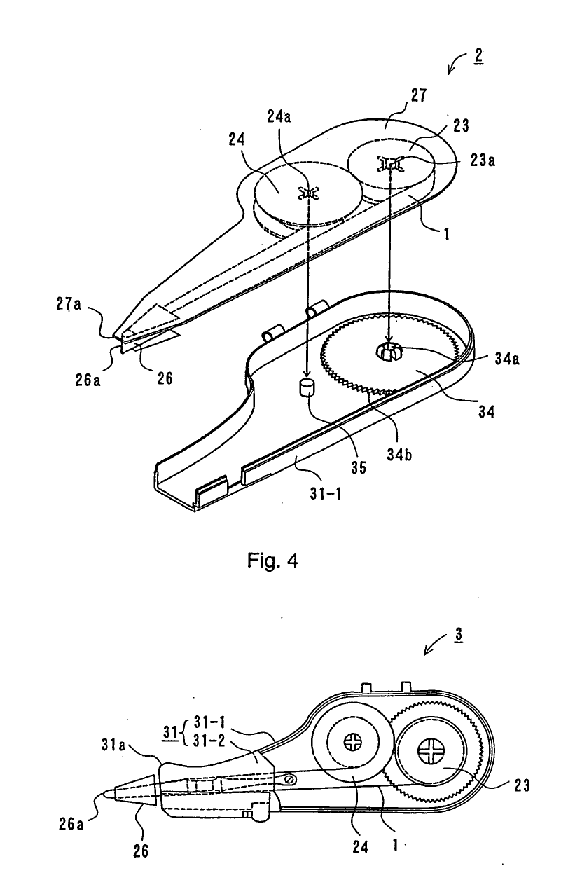

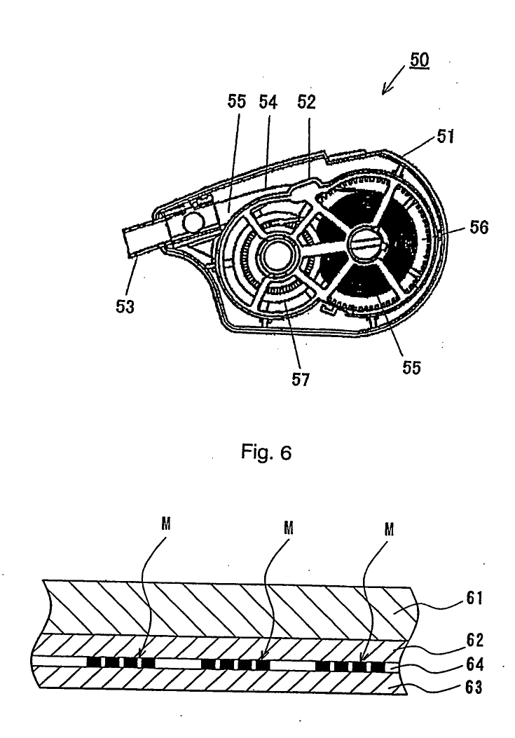

FIG. 3 is a perspective view schematically illustrating the mark transfer tape cartridge according to an embodiment of the present invention. FIG. 3 also shows the relation between the mark transfer tape cartridge and the case of the mark transfer tool. FIG. 4 is a cross section view schematically illustrating the configuration inside the mark transfer tool according to an embodiment of the present invention.

In the mark transfer tape cartridge 2 shown in FIG. 3, a supply reel 23 and a take-up reel 24 are rotatably disposed on one surface of a support plate 27, and a transfer head 26 is further disposed at the leading end of the support plate 27. A detailed description on the mechanism is omitted. It is preferable that a pressure blade 26a of the transfer head 26 is movable so as to come in and go out relative to the leading end 27a of the support plate 27 in the axial direction of the mark transfer tape cartridge 2.

As shown in FIG. 3, the mark transfer tape cartridge 2 is configured such that a center hole 23a of the supply reel 23 engages a rotation axis 34a of a gear 34 which is rotatably attached to a case body 31-1, and a central hole 24a of the take-up reel 24 engages a holding portion 35. Gear teeth 34b of the gear 34 engage gear teeth of another gear (not shown) provided at the take-up reel 24, thereby adjusting the supply rate and take-up rate of the mark transfer tape 1.

The mark transfer tape installed in the mark transfer tape cartridge 2 is the mark transfer tape 1 of an embodiment of the present invention. When a mark is transferred to a transfer target, such as a sheet of paper, using a mark transfer tool in which the mark transfer tape cartridge 2 is installed, the transferred mark is distinct and does not deform due to cracking or elongation.

The mark transfer tool 3 shown in FIG. 4 is configured such that the mark transfer tape cartridge 2 according to the above-described embodiment of the present invention is installed in a case 31, and the mark transfer tape cartridge 2 is removably attached to the case body 31-1 in the manner shown in FIG. 3. After the mark transfer tape cartridge 2 is installed in the case body 31-1, a case lid 31-2 covers the case body 31-1.

The principal parts of the mark transfer tool 3 consist of the supply reel (supply part) 23, the take-up reel (take-up part) 24, the transfer head 26, the mark transfer tape 1, etc., which are installed in the mark transfer tape cartridge 2. The transfer head 26 projects from a leading end portion 31a of the case 31. In this configuration, the mark transfer tape 1 wound onto the supply reel 23 is fed from the supply reel 23, a mark is transferred with a pressure blade 26a of the transfer head 26, and then the base tape 11 of the mark transfer tape 1 is taken up on the take-up reel 24. The supply reel 23 and the take-up reel 24 interlock with each other, and are adjusted so that no slack, etc. may arise in the tension of the supplied mark transfer tape 1.

FIGS. 3 and 4 show one example of the mechanism of each part and the entire configuration of the transfer tape cartridge 2 and the mark transfer tool 3. Any type of tape transfer cartridge and mark transfer tool, such as the type shown in FIG. 5, can be used as long as the configuration and mechanism of the parts other than the mark transfer tape 1 permit transfer of the coating film of the mark transfer tape 1.

A mark transfer tool can be configured according to another embodiment such that the supply reel 23, the take-up reel 24, the transfer head 26, etc., are integrally installed in the case 31 without using the mark transfer tape cartridge 2. The principal parts of such a configuration are almost the same as those of the mark transfer tool 3 according to this embodiment except that the support plate 27 of the mark transfer tape cartridge 2 is not provided, and thus the detailed descriptions are omitted.

The mark transfer tape 1 according to this embodiment is mounted in the above-described mark transfer tool 3 or a mark transfer tool according to another embodiment, and marks transferred using such a mark transfer tool to a transfer subject, such as a sheet of paper, are distinct and do not deform due to cracking or elongation.

### EXAMPLES

The transfer properties of the mark transfer tape 1 were examined using the mark transfer tool 3 shown in FIG. 4. Comparative tests were carried out by replacing only the mark transfer tape of the mark transfer tool 3 with other tapes.

(1) Test Method

Tables 1 and 2 show the components for forming the surface protective layer 12 and the pressure sensitive adhesive layer 13 in Examples 1 and 2, and in Comparative Examples 1 to 3, respectively. The properties relating to the components for the surface protective layer and the pressure sensitive adhesive layer were changed by varying these components.

TABLE 1

| | | | |
|---|---|---|---|
| | | | Amounts |
| Examples | Solutions | Components | (W %) |

| | | | |
|---|---|---|---|
| Example 1 | 1-A solution | Styrene-butadiene type block | 19.4 |
| | | copolymer | |
| | | Antioxidant | 0.4 |
| | | Ultraviolet absorber | 0.2 |
| | | Toluene | 80 |
| | 1-B solution | Acryl emulsion type adhesive | 20 |
| | | Purified water | 70 |
| | | Isopropyl alcohol | 10 |
| Example 2 | 2-A solution | Urethane resin | 34.8 |
| | | Blue dye | 0.2 |
| | | Isopropyl alcohol | 65 |
| | 2-B solution | Rubber type adhesive | 29 |
| | | Tackifier | 0.4 |
| | | Antioxidant | 0.4 |
| | | Ultraviolet absorber | 0.2 |
| | | Toluene | 70 |

TABLE 2

| | | | Amounts |
|---|---|---|---|
| Examples | Solutions | Components | (W %) |
| Comp. Exam. 1 | 1-C solution | Styrene-butadiene block | 10 |
| | | copolymer | |
| | | White pigment | 26 |
| | | Surfactant | 3 |
| | | Antioxidant | 0.6 |
| | | Ultraviolet absorber | 0.4 |
| | | Toluene | 60 |
| | 1-D solution | Vinyl ether type adhesive | 30 |
| | | Extender pigment | 2 |
| | | Aliphatic type hydrocarbon | 38 |
| | | Toluene | 30 |
| Comp. Exam. 2 | 2-C solution | Polyethylene type resin | 25 |
| | | Methyl ethyl ketone | 40 |
| | | Toluene | 35 |
| Comp. Exam. 2 | 2-D solution | Acrylic resin | 10 |
| | | Isopropyl alcohol | 30 |
| Comp. Exam. 3 | 3-C solution | Urethane type resin | 20 |
| | | Methyl ethyl ketone | 20 |
| | | Isopropyl alcohol | 60 |
| | 3-D solution | Acryl emulsion type adhesive | 20 |
| | | Purified water | 70 |
| | | Isopropyl alcohol | 10 |

In Example 1, a polyethylene phthalate film which was about 500 mm wide and 16 μm thick and was provided with release layers on both surfaces was used for the base tape 11. The surface protective layer 12 was formed on one surface of the base tape 11 by applying a 1-A solution by reverse printing and drying the applied solution at about 80° C. so that the thickness after drying would be 10 μm. Subsequently, a pattern (mark) of a pink-colored heart shape about 5 mm long and about 5 mm wide was printed by gravure printing on the surface protective layer 12. The pressure sensitive adhesive layer 13 was further formed thereon by applying a 1-B solution by gravure printing and drying the applied solution at about 100° C. so that the thickness after drying would be 1 μm.

A film on which the coating film was formed was slit to a width of 6 mm, to obtain a mark transfer tape 1. The obtained mark transfer tape 1 was used for manufacturing the mark transfer tool 1 shown in FIG. 4. The properties of the coating film were examined by pressing and transferring a mark to a fine quality paper of white solid color with the mark transfer tool 1.

The thickness of the surface protective layer 12 was measured with a scanning electron microscope (SEM), and the total luminous transmittance and the elongation percentage thereof were measured as to samples produced using a only material constituting the surface protective layer by the test methods prescribed in ASTM D-1003 and D-412, respectively. The production method for the sample has already been described, and thus the description is omitted. The transfer properties of the coating film were visually observed as to the cutting performance of the transferred coating film, the visibility of the transferred pattern (mark), and the occurrence of cracking.

In Example 2, the mark transfer tape 1 was produced in almost the same manner as in Example 1, and thus the description is omitted. Example 2 is different from Example 1 with respect to the components shown in Table 1 and the following matter. Glassine with a thickness of 40 μm was used for the base tape 11. The thickness of the surface protective layer 12 after drying was 8 μm. The pattern consisted of the letters of the alphabet, “ABC”, the color thereof was blue and the size thereof was about 4 mm long and about 15 mm wide. The thickness of the pressure sensitive adhesive layer 13 after drying was 1 μm.

In Comparative Example 1, a polyethylene-terephthalate film with a thickness of 12 μm was used for the base tape 11. The thickness of the surface protective layer 12 after drying was 25 μm. The pattern consisted of Hiragana characters which correspond to 5 vowels “a i u e o” in the Japanese Syllabary, the pattern was in four colors, and the size thereof was about 24 mm long and about 24 mm wide. The thickness of the pressure sensitive adhesive layer 13 after drying was 2 μm. According to the above-described conditions, a mark transfer tape was produced in which the thickness of the surface protective layer was above the range specified by the present invention, and the total luminous transmittance was below the range specified by the present invention. The total luminous transmittance of the surface protective layer was lowered by adding white pigment.

In Comparative Example 2, a polyethylene-terephthalate film with a thickness of 16 μm was used for the base tape 11. The thickness of the surface protective layer 12 after drying was 0.8 μm. The pattern consisted of star shapes, the color thereof was green, and the size thereof was about, 3.5 mm long and about 3.5 mm wide. The thickness of the pressure sensitive adhesive layer 13 after drying was 1 μm. According to the above-described conditions, a mark transfer tape was produced in which the thickness of the surface protective layer was below the range specified by the present invention, and the elongation percentage was below the range specified by the present invention. The elongation percentage of the surface protective layer was lowered by adding polyethylene resin.

In Comparative Example 3, glassine with a thickness of 40 μm was used for the base tape 11. The thickness of the surface protective layer 12 after drying was 10 μm. The pattern consisted of star shapes, the color thereof was green, and the size thereof was about 3.5 mm long and about 3.5 mm wide. The thickness of the pressure sensitive adhesive layer 13 after drying was 2 μm. According to the above-described conditions, a mark transfer tape was produced in which the elongation percentage of the surface protective layer was above the range specified by the present invention. The elongation percentage of the surface protective layer was increased by adding urethane resin.

(2) Test Results

Table 3 shows the test results.

TABLE 3

| | | Ex- | | Comparative | | |
|---|---|---|---|---|---|---|
| | | amples | | Examples | | |
| Items | | 1 | 2 | 1 | 2 | 3 |
| Surface | Thickness (μm) | 10 | 8 | 25 | 0.8 | 10 |
| protective | Total luminous transmittance | 92 | 84 | 33 | 92 | 90 |
| layer | (%) | | | | | |
| | Elongation percentage (%) | 80 | 105 | 67 | 8.4 | 225 |

| | | | | | |
|---|---|---|---|---|---|
| Visibility of the mark*¹ | ◯ | ◯ | X | X | X |
| Cutting performance of the transferred | ◯ | ◯ | X | ◯ | X |
| coating film*² | | | | | |
| Cracking in the transferred mark*³ | ◯ | ◯ | ◯ | X | ◯ |

*¹Visibility of the mark: ◯: Good, X: Poor (indistinct, deformed, etc.)
*²Cutting performance of the transferred coating film: ◯: Good, X: Poor
*³Cracking in the transferred coating film: ◯: Not found, X: Found

As is evident from Table 3, the test results of Examples 1 and 2 showed that the thickness, total luminous transmittance, and elongation percentage of the surface protective layer 12 satisfy the conditions specified by the present invention. Therefore, the transferred coating film showed excellent cutting performance, the outline and color of the transferred mark were distinct, and no cracking was observed in the transferred coating film. Thus, the coating film showed satisfactory transferring characteristics.

On the other hand, the test results of Comparative Examples 1 to 3 showed that at least one of the properties, i.e., the cutting performance of the transferred coating film, the visibility of the transferred mark, or the presence of cracking in the transferred coating film, was poor. Thus, the transferring property of the coating film was unsatisfactory. The test results of Comparative Example 1 showed a poor cutting performance of the transferred coating film due to an excessively thick surface protective layer, and poor visibility of the transferred mark due to an excessively low total luminous transmittance. The test results of Comparative Example 2 showed that cracking occurred in the transferred coating film and mark due to an excessively thin surface protective layer and an excessively low elongation percentage thereof. The test results of Comparative Example 3 showed that the cutting performance of the transfer coating film is poor due to an excessively high elongation percentage of the surface protective layer and that the visibility was also bad due to deformation of the transferred mark.

1. A mark transfer tape comprising:
a base tape, and
at least a surface protective layer, a mark layer, and a pressure sensitive adhesive layer, the layers being laminated in this order on one surface of the base tape, wherein
the surface protective layer has a thickness of 1 to 20 μm, a total luminous transmittance of 50% or more, and an elongation percentage of 20 to 200% at ordinary temperatures.

2. A mark transfer tape cartridge installed in a mark transfer tool comprising:
a supply unit, a take-up unit, and a transfer head for a mark transfer tape, wherein
the mark transfer tape is fed from the supply unit, and is taken up on the take-up unit via the transfer head unit, and
the mark transfer tape is the mark transfer tape of claim 1.

3. A mark transfer tool comprising:
a case forming an outer frame, and
a mark transfer tape cartridge of claim 2 removably installed in the case.

4. A mark transfer tool comprising:
a case forming an outer frame in which a supply unit, a take-up unit, and a transfer head unit for a mark transfer tape are installed, wherein
the mark transfer tape is fed from the supply unit, and is taken up on the take-up unit via the transfer head unit, and
the mark transfer tape is the mark transfer tape of claim 1.
